(19) United States
(12) Patent Application Publication
(10) Pub. No.: US 2022/0134436 A1
(43) Pub. Date: May 5, 2022

(54) THREE-DIMENSIONAL SHAPING APPARATUS

(71) Applicant: Seiko Epson Corporation, Tokyo (JP)

(72) Inventor: Takeshi MIYASHITA, Sendai-shi (JP)

(21) Appl. No.: 17/512,923

(22) Filed: Oct. 28, 2021

(30) Foreign Application Priority Data
Oct. 30, 2020 (JP) 2020-182367

(51) Int. Cl. B22F 10/80; B33Y 30/00; B33Y 50/02; B28B 1/00; B28B 17/00

(52) U.S. Cl. CPC B22F 10/80; B33Y 30/00; B28B 17/0081; B28B 1/001; B33Y 50/02

(57) ABSTRACT

A three-dimensional shaping apparatus that forms a stacked body, wherein among multiple second shaped layers constituting the stacked body, a first layer is in contact with a first shaped layer, a second layer is in contact with a third shaped layer, a third layer is located between the first layer and the second layer, a fourth layer is located between the first layer and the third layer, the second shaped layer includes a first material region formed of a first material and a second material region formed of a second material, and when viewed from a stacking direction of the stacked body, an area of the first material region of the first layer is larger than an area of the first material region of the fourth layer, an area of the second material region of the second layer is larger than an area of the second material region of the third layer, and an area of the first material region of the third layer is larger than an area of the first material region of the first layer.

The present application is based on, and claims priority from JP Application Serial Number 2020-182367, filed Oct. 30, 2020, the disclosure of which is hereby incorporated by reference herein in its entirety.

### BACKGROUND

### 1. Technical Field

The present disclosure relates to a three-dimensional shaping apparatus.

### 2. Related Art

A three-dimensional shaping apparatus that shapes a three-dimensional shaped article using multiple materials is known. By using multiple materials, a three-dimensional shaped article having characteristics that cannot be obtained with a single material or alloy can be shaped.

For example, WO 2017/110001 describes a method for shaping a three-dimensional shaped article in which a boundary where different types of materials alternately appear in a vertical direction that is vertical with respect to a stacking direction of the materials is formed.

When a three-dimensional shaped article is shaped using multiple materials as described above, adhesion at the boundary of the mutually different materials poses a problem.

### SUMMARY

One aspect of a three-dimensional shaping apparatus according to the present disclosure includes a stage, a first material supply unit that supplies a first material; a second material supply unit that supplies a second material different from the first material; and a control unit, in which the control unit performs a process of supplying the first material onto the stage by controlling the first material supply unit, thereby forming a first shaped layer, a process of supplying the first material onto a first region of the first shaped layer by controlling the first material supply unit, and supplying the second material onto a second region that is different from the first region of the first shaped layer by controlling the second material supply unit, thereby forming a second shaped layer, a process of repeating supply of the first material and supply of the second material multiple times, thereby forming a stacked body composed of multiple second shaped layers, and a process of supplying the second material onto the stacked body by controlling the second material supply unit, thereby forming a third shaped layer, a first layer among the multiple second shaped layers constituting the stacked body is in contact with the first shaped layer, a second layer among the multiple second shaped layers constituting the stacked body is in contact with the third shaped layer, a third layer among the multiple second shaped layers constituting the stacked body is located between the first layer and the second layer, a fourth layer among the multiple second shaped layers constituting the stacked body is located between the first layer and the third layer, the second shaped layer includes a first material region formed of the first material and a second material region formed of the second material, and when viewed from a stacking direction of the stacked body, an area of the first material region of the first layer is larger than an area of the first material region of the fourth layer, an area of the second material region of the second layer is larger than an area of the second material region of the third layer, and an area of the first material region of the third layer is larger than an area of the first material region of the first layer.

### BRIEF DESCRIPTION OF THE DRAWINGS

FIG. 1 is a cross-sectional view schematically showing a three-dimensional shaping apparatus according to the present embodiment.

FIG. 2 is a cross-sectional view schematically showing a three-dimensional shaped article to be shaped by the three-dimensional shaping apparatus according to the present embodiment.

FIG. 3 is a cross-sectional view schematically showing the three-dimensional shaped article to be shaped by the three-dimensional shaping apparatus according to the present embodiment.

FIG. 4 is a perspective view schematically showing the three-dimensional shaped article to be shaped by the three-dimensional shaping apparatus according to the present embodiment.

FIG. 5 is a plan view schematically showing a first layer of the three-dimensional shaped article to be shaped by the three-dimensional shaping apparatus according to the present embodiment.

FIG. 6 is a plan view schematically showing a second layer of the three-dimensional shaped article to be shaped by the three-dimensional shaping apparatus according to the present embodiment.

FIG. 7 is a flowchart for explaining processes of a control unit of the three-dimensional shaping apparatus according to the present embodiment.

FIG. 8 is a cross-sectional view schematically showing a step of producing a three-dimensional shaped article to be shaped by the three-dimensional shaping apparatus according to the present embodiment.

FIG. 9 is a cross-sectional view schematically showing a step of producing a three-dimensional shaped article to be shaped by the three-dimensional shaping apparatus according to the present embodiment.

### DESCRIPTION OF EXEMPLARY EMBODIMENTS

Hereinafter, preferred embodiments of the present disclosure will be described in detail using the drawings. Note that the embodiments described below are not intended to unduly limit the contents of the present disclosure described in the appended claims. Further, all the configurations described below are not necessarily essential configuration requirements of the present disclosure.

### 1. Three-Dimensional Shaping Apparatus

### 1.1. Overall Configuration

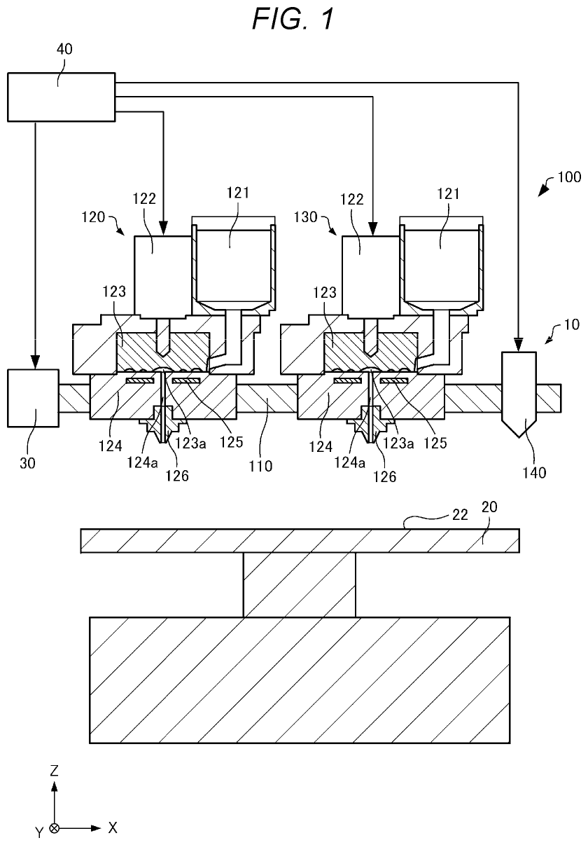

First, a three-dimensional shaping apparatus according to the present embodiment will be described with reference to the drawings. FIG. 1 is a cross-sectional view schematically showing a three-dimensional shaping apparatus 100 according to the present embodiment. Note that in FIG. 1, as three axes orthogonal to one another, X axis, Y axis, and Z axis are shown. An X-axis direction and a Y-axis direction are each, for example, a horizontal direction. A Z-axis direction is, for example, a vertical direction.

The three-dimensional shaping apparatus 100 includes, for example, a shaping unit 10, a stage 20, a moving unit 30, and a control unit 40 as shown in FIG. 1.

The shaping unit 10 includes, for example, a support member 110, a first material supply unit 120, a second material supply unit 130, and a laser 140.

The support member 110 is, for example, a plate-shaped member. The support member 110 supports the first material supply unit 120, the second material supply unit 130, and the laser 140.

The first material supply unit 120 supplies a first material. The first material is, for example, a metal material. Examples of the metal material include single metals of magnesium (Mg), iron (Fe), cobalt (Co), chromium (Cr), aluminum (Al), titanium (Ti), copper (Cu), and nickel (Ni), or alloys containing one or more of these metals, and a maraging steel, a stainless steel (SUS), cobalt-chromium-molybdenum, a titanium alloy, a nickel alloy, an aluminum alloy, a cobalt alloy, and a cobalt-chromium alloy.

The first material supply unit 120 includes, for example, a material introduction portion 121, a motor 122, a flat screw 123, a barrel 124, a heater 125, and a nozzle 126.

The material introduction portion 121 of the first material supply unit 120 introduces a first material into a groove 123a provided in a face at the barrel 124 side of the flat screw 123. The first material to be introduced into the groove 123a is, for example, in a powder form. The flat screw 123 is rotated by the motor 122. The heater 125 is provided in the barrel 124. The first material is plasticized in the groove 123a by the heat of the heater 125. The plasticized first material passes through a communication hole 124a provided in the barrel 124, and is ejected to the stage 20 from the nozzle 126. The ejected first material becomes in a state where fluidity is lost on the stage 20.

The second material supply unit 130 supplies a second material that is different from the first material. The second material is, for example, a ceramic material. Examples of the ceramic material include oxide ceramics such as silicon dioxide, titanium dioxide, aluminum oxide, and zirconium oxide, and non-oxide ceramics such as aluminum nitride.

The second material supply unit 130 includes, for example, a material introduction portion 121, a motor 122, a flat screw 123, a barrel 124, a heater 125, and a nozzle 126. The second material supply unit 130, for example, has the same configuration as that of the first material supply unit 120.

The laser 140 irradiates the first material and the second material with a laser beam. The laser is, for example, a YAG (Yttrium Aluminum Garnet) laser, a fiber laser, a UV (ultraviolet) laser, or the like.

The stage 20 is provided below the shaping unit 10. To a shaping face 22 of the stage 20, the first material and the second material are supplied and a three-dimensional shaped article is formed.

The moving unit 30 changes the relative position of the shaping unit 10 to the stage 20. The moving unit 30, for example, simultaneously changes the relative position between the stage 20 and the first material supply unit 120, the relative position between the stage 20 and the second material supply unit 130, and the relative position between the stage 20 and the laser 140. In the illustrated example, the stage 20 is fixed, and the moving unit 30 moves the shaping unit 10 with respect to the stage 20. According to this, the relative positions between the stage 20 and the first material supply unit 120, between the stage 20 and the second material supply unit 130, and between the stage 20 and the laser 140 can be changed. In the illustrated example, the moving unit 30 is coupled to the support member 110, and moves the shaping unit 10 by moving the support member 110.

The moving unit 30 is constituted by, for example, a three-axis positioner for moving the shaping unit 10 in the X-axis direction, Y-axis direction, and Z-axis direction by the driving forces of unillustrated three motors. The motors of the moving unit 30 are controlled by the control unit 40.

The moving unit 30 may be configured to move the stage 20 without moving the shaping unit 10. In this case, the moving unit 30 is coupled to the stage 20. Further, the moving unit 30 may be configured to move both the shaping unit 10 and the stage 20. In this case, the moving unit 30 is coupled to both the shaping unit 10 and the stage 20.

The control unit 40 is constituted by, for example, a computer including a processor, a main storage device, and an input/output interface for performing signal input/output to/from the outside. The control unit 40 exhibits various functions, for example, by execution of a program read in the main storage device by the processor. The control unit 40 controls the shaping unit 10 and the moving unit 30. Specific processes of the control unit 40 will be described later. The control unit 40 may be constituted by a combination of multiple circuits instead of a computer.

### 1.2. Configuration of Three-Dimensional Shaped Article

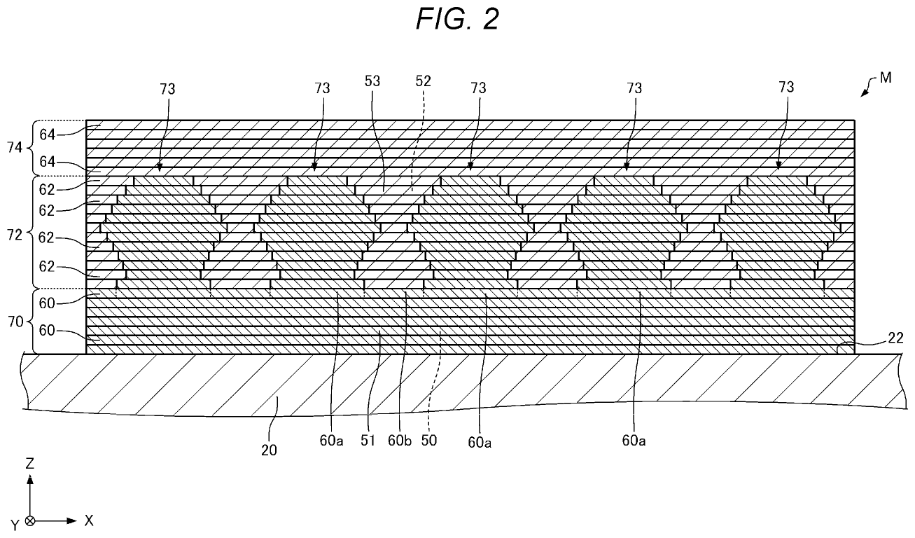

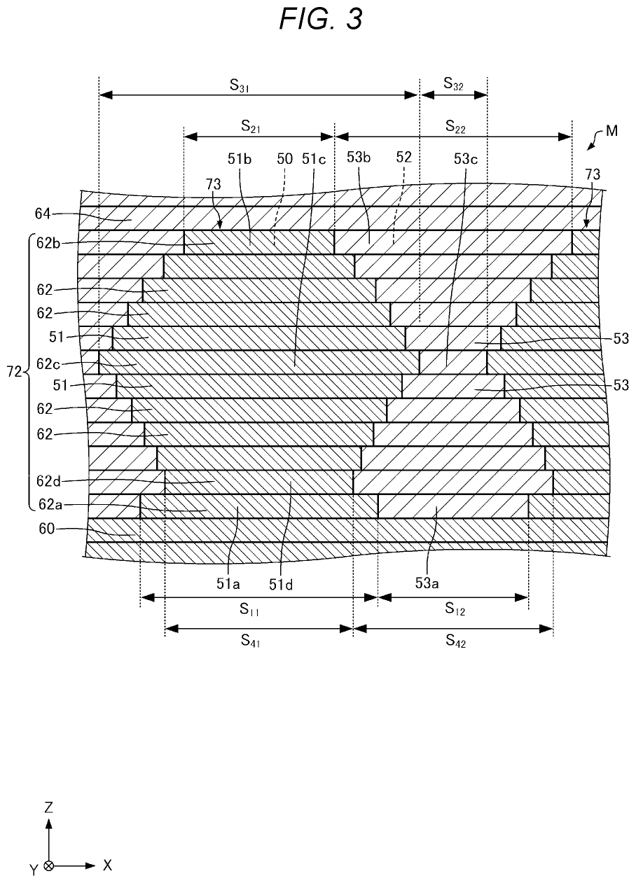

FIG. 2 is a cross-sectional view schematically showing a three-dimensional shaped article M to be shaped by the three-dimensional shaping apparatus 100. FIG. 3 is an enlarged view of the three-dimensional shaped article M shown in FIG. 2.

As shown in FIGS. 2 and 3, the three-dimensional shaped article M includes a first stacked body 70, a second stacked body 72, and a third stacked body 74.

The first stacked body 70 is provided on the stage 20, and is constituted by multiple first shaped layers 60. The first shaped layer 60 contains a first material 50, and does not contain a second material 52. Among the multiple first shaped layers 60 constituting the first stacked body 70, the first shaped layer 60 that is in contact with the second stacked body 72 includes a first region 60a and a second region 60b that is different from the first region 60a. In the illustrated example, the first shaped layer 60 that is in contact with the second stacked body 72 is provided on the stage 20 through six first shaped layers 60. On the first region 60a, a first material region 51 of a second shaped layer 62 is formed. On the second region 60b, a second material region 53 of the second shaped layer 62 is formed.

The second stacked body 72 is provided between the first stacked body 70 and the third stacked body 74, and is constituted by multiple second shaped layers 62. The second stacked body 72 has multiple convex portions 73. The convex portion 73 is constituted by the first material 50. The convex portion 73 has a shape protruding from the first stacked body 70. The second shaped layer 62 includes the first material region 51 formed of the first material 50 and the second material region 53 formed of the second material 52. The first material region 51 constitutes a part of the convex portion 73. In the second shaped layer 62 that is in contact with the first stacked body 70 among the multiple second shaped layers 62 constituting the second stacked body 72, the first material region 51 is formed on the first region 60a, and the second material region 53 is formed on the second region 60b.

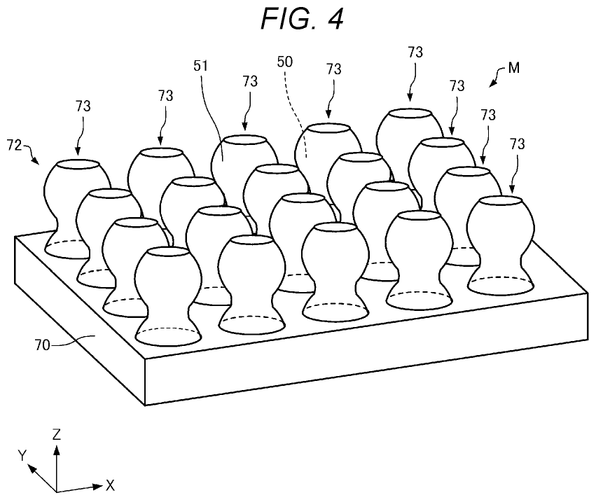

Here, FIG. 4 is a perspective view schematically showing the convex portions 73 of the second stacked body 72. Note that in FIG. 4, the convex portions 73 are shown in a simplified manner for the sake of convenience. As shown in FIG. 4, multiple convex portions 73 are provided. In the illustrated example, the multiple convex portions 73 are provided in a matrix form in the X-axis direction and the Y-axis direction. Hereinafter, the number of convex portions 73 is denoted by n. The shapes and sizes of n convex portions 73 are, for example, mutually equal.

As shown in FIG. 3, a first layer 62a among the multiple second shaped layers 62 constituting the second stacked body 72 (hereinafter also simply referred to as “in the second stacked body 72”) is in contact with the first stacked body 70. A second layer 62b in the second stacked body 72 is in contact with the third stacked body 74. A third layer 62c in the second stacked body 72 is located between the first layer 62a and the second layer 62b. A fourth layer 62d in the second stacked body 72 is located between the first layer 62a and the third layer 62c. In the illustrated example, the fourth layer 62d is in contact with the first layer 62a.

When viewed from a stacking direction of the second stacked body 72 (hereinafter also simply referred to as “when viewed from the stacking direction”), an area nS₁₁ of a first material region 51a of the first layer 62a is larger than an area nS₄₁ of a first material region 51d of the fourth layer 62d. An area nS₂₂ of a second material region 53b of the second layer 62b is larger than an area nS₃₂ of a second material region 53c of the third layer 62c. An area nS₃₁ of a first material region 51c of the third layer 62c is larger than the area nS₁₁ of the first material region 51a of the first layer 62a. In the illustrate example, the stacking direction is the Z-axis direction.

When viewed from the stacking direction, in the third layer 62c, for example, the area of the first material region 51c is the largest in the second stacked body 72. In the third layer 62c, the area of the second material region 53c is the smallest in the second stacked body 72.

When viewed from the stacking direction, in the fourth layer 62d, for example, the area of the first material region 51 is the smallest among the multiple second shaped layers 62 located between the first layer 62a and the third layer 62c. The area of the first material region 51 in each of the second shaped layers 62, for example, gradually increases from the fourth layer 62d to the third layer 62c, and gradually decreases from the third layer 62c to the second layer 62b.

When viewed from the stacking direction, in the fourth layer 62d, the area of the second material region 53 is the largest among the multiple second shaped layers 62 located between the first layer 62a and the third layer 62c. The area of the second material region 53 in each of the second shaped layers 62, for example, gradually decreases from the fourth layer 62d to the third layer 62c, and gradually increases from the third layer 62c to the second layer 62b.

The first material region 51a is the first material region 51 included in the first layer 62a among the multiple first material regions 51. The first material region 51b is the first material region 51 included in the second layer 62b among the multiple first material regions 51. The first material region 51c is the first material region 51 included in the third layer 62c among the multiple first material regions 51. The first material region 51d is the first material region 51 included in the fourth layer 62d among the multiple first material regions 51.

Further, a second material region 53a is the second material region 53 included in the first layer 62a among the multiple second material regions 53. The second material region 53b is the second material region 53 included in the second layer 62b among the multiple second material regions 53. The second material region 53c is the second material region 53 included in the third layer 62c among the multiple second material regions 53.

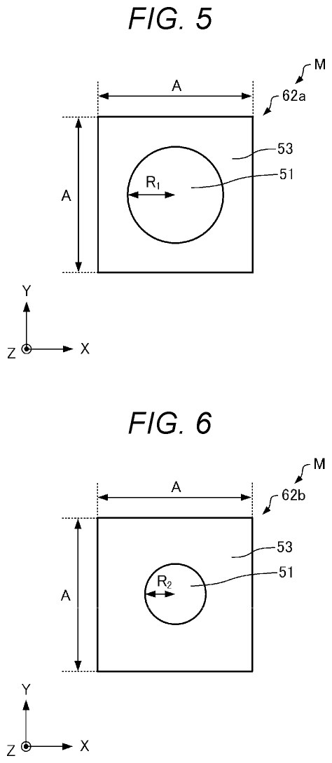

When viewed from the stacking direction, the area nS₁₁ of the first material region 51a of the first layer 62a and the area nS₂₂ of the second material region 53b of the second layer 62b are, for example, mutually equal. Here, FIG. 5 is a plan view schematically showing a part of the first layer 62a. FIG. 6 is a plan view schematically showing a part of the second layer 62b.

As shown in FIG. 5, in the first layer 62a, a circle having a radius R₁ is assumed in a square having a side length of A. In the first layer 62a, when the area of the circle is defined as an area S₁₁ of the first material region 51a and an area resulting from subtracting the area S₁₁ from the square is defined as an area S₁₂ of the second material region 53a, the area S₁₁ and the area S₁₂ are represented as follows.

S₁₁=πR₁²

S₁₂=A²−πR₁²

As shown in FIG. 6, in the second layer 62b, a circle having a radius R₂ is assumed in a square having a side length of A. In the second layer 62b, when the area of the circle is defined as an area Sn of the first material region 51b and an area resulting from subtracting the area Sn from the square is defined as an area S₂₂ of the second material region 53b, the area S₂₁ and the area S₂₂ are represented as follows.

S₂₁=πR₂²

S₂₂=A²−πR₂²

Therefore, when the area S₁₁ and the area S₂₂ are mutually equal, the radius R₁ is represented as follows.

$${R}_{1} = \sqrt{\frac{{A}^{2}}{π} - {R}_{2}^{2}}$$

The third stacked body 74 is provided on the second stacked body 72, and is constituted by multiple third shaped layers 64. The third shaped layer 64 contains the second material 52 and does not contain the first material 50.

### 1.3. Processes of Control Unit

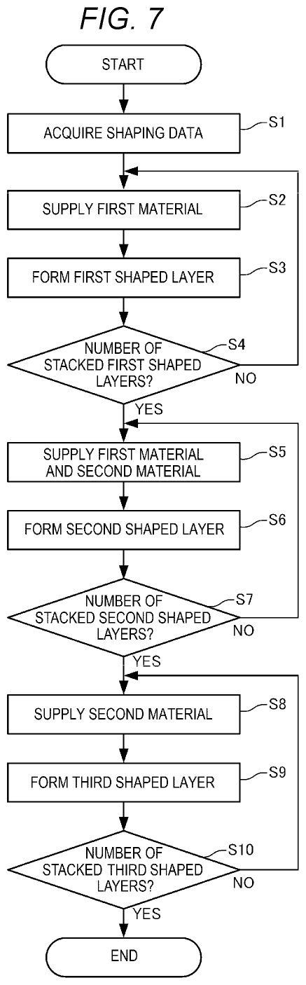

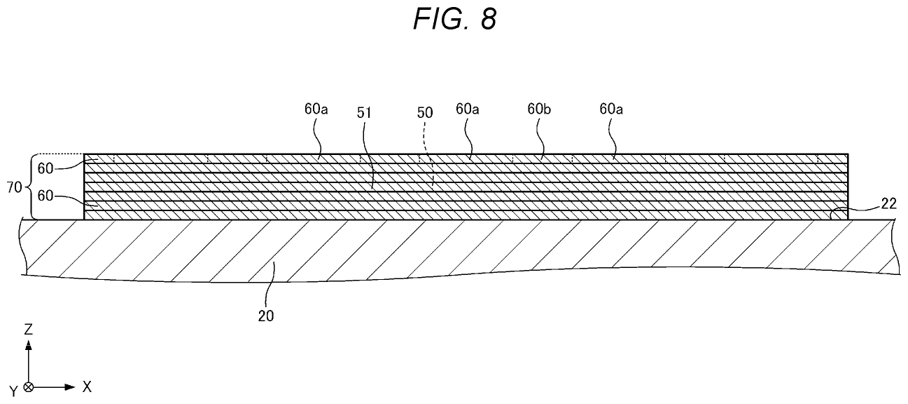

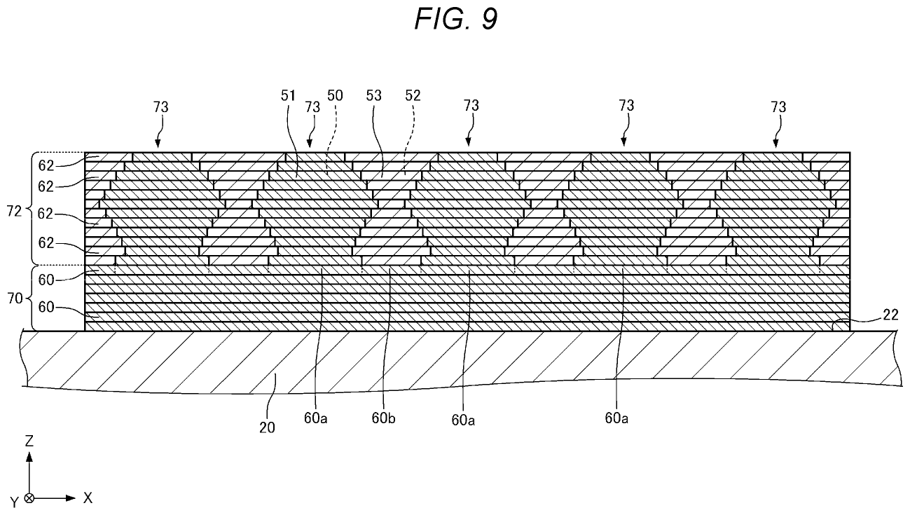

The control unit 40 controls the moving unit 30, the first material supply unit 120, the second material supply unit 130, and the laser 140. FIG. 7 is a flowchart for explaining processes of the control unit 40. FIGS. 8 and 9 are cross-sectional views schematically showing a step of producing a three-dimensional shaped article M to be produced by the three-dimensional shaping apparatus 100.

A user, for example, operates an unillustrated operation unit and transmits a process start signal to the control unit 40. The operation unit is realized by, for example, a mouse, a keyboard, a touch panel, or the like. The control unit 40 starts a process as shown in FIG. 7 when receiving the process start signal.

First, the control unit 40 performs a process of acquiring shaping data (Step S1). The shaping data are shaping data for shaping a three-dimensional shaped article. The shaping data include information regarding the shape, size, material, etc. of the three-dimensional shaped article to be shaped. The processes of the control unit 40 described below are performed based on the shaping data. The shaping data are generated by, for example, slicer software installed on the computer coupled to the three-dimensional shaping apparatus 100. The control unit 40 acquires the shaping data from the computer coupled to the three-dimensional shaping apparatus 100 or a recording medium such as a USB (Universal Serial Bus) memory.

Subsequently, the control unit 40 performs a process of supplying the first material 50 onto the stage 20 by controlling the first material supply unit 120 while moving the shaping unit 10 with respect to the stage 20 by controlling the moving unit 30 (Step S2).

Subsequently, the control unit 40 performs a process of forming the first shaped layer 60 by irradiating the first material 50 on the stage 20 with a laser beam by controlling the laser 140 while moving the shaping unit 10 with respect to the stage 20 by controlling the moving unit 30 (Step S3). By irradiating the first material 50 with a laser beam, the first material 50 is sintered or melted, whereby the first shaped layer 60 having high flatness can be formed.

Subsequently, the control unit 40 performs a process of determining whether or not the number of stacked first shaped layers 60 becomes a predetermined number based on the acquired shaping data (Step S4). When it is determined that the number of stacked first shaped layers 60 does not become the predetermined number (“NO” in Step S4), the control unit 40 returns the process to Step S2 and repeats Step S2 and Step S3 until the number of stacked first shaped layers 60 becomes the predetermined number. By doing this, as shown in FIG. 8, the first stacked body 70 composed of multiple first shaped layers 60 can be formed. When it is determined that the number of stacked first shaped layers 60 becomes the predetermined number (“YES” in Step S4), the control unit 40 allows the process to proceed to Step S5.

In Step S5, the control unit 40 performs a process of supplying the first material 50 onto the first region 60a of the first shaped layer 60 by controlling the first material supply unit 120 and supplying the second material 52 onto the second region 60b of the first shaped layer 60 by controlling the second material supply unit 130 while moving the shaping unit 10 with respect to the stage 20 by controlling the moving unit 30 (Step S5).

Subsequently, the control unit 40 performs a process of forming the second shaped layer 62 by irradiating the first material 50 and the second material 52 on the first shaped layer 60 with a laser beam by controlling the laser 140 while moving the shaping unit 10 with respect to the stage 20 by controlling the moving unit 30 (Step S6).

Subsequently, the control unit 40 performs a process of determining whether or not the number of stacked second shaped layers 62 becomes a predetermined number based on the acquired shaping data (Step S7). When it is determined that the number of stacked second shaped layers 62 does not become the predetermined number (“NO” in Step S7), the control unit 40 returns the process to Step S5 and repeats Step S5 and Step S6 until the number of stacked second shaped layers 62 becomes the predetermined number. By doing this, as shown in FIG. 9, the second stacked body composed of multiple second shaped layers 62 can be formed. When it is determined that the number of stacked second shaped layers 62 becomes the predetermined number (“YES” in Step S7), the control unit 40 allows the process to proceed to Step S8.

In Step S8, the control unit 40 performs a process of supplying the second material 52 onto the second stacked body 72 by controlling the second material supply unit 130 while moving the shaping unit 10 with respect to the stage 20 by controlling the moving unit 30 (Step S8).

Subsequently, the control unit 40 performs a process of forming the third shaped layer 64 by irradiating the second material 52 on the second stacked body 72 with a laser beam by controlling the laser 140 while moving the shaping unit 10 with respect to the stage 20 by controlling the moving unit 30 (Step S9).

Subsequently, the control unit 40 performs a process of determining whether or not the number of stacked third shaped layers 64 becomes a predetermined number based on the acquired shaping data (Step S10). When it is determined that the number of stacked third shaped layers 64 does not become the predetermined number (“NO” in Step S10), the control unit 40 returns the process to Step S8 and repeats Step S8 and Step S9 until the number of stacked third shaped layers 64 becomes the predetermined number. By doing this, as shown in FIG. 2, the third stacked body 74 composed of multiple third shaped layers 64 can be formed. When it is determined that the number of stacked third shaped layers 64 becomes the predetermined number (“YES” in Step S10), the control unit 40 terminates the process.

### 1.4. Operational Effects

According to the three-dimensional shaping apparatus 100, among the multiple second shaped layers 62 constituting the second stacked body 72, the first layer 62a is in contact with the first shaped layer 60, the second layer 62b is in contact with the third shaped layer 64, the third layer 62c is located between the first layer 62a and the second layer 62b, and the fourth layer 62d is located between the first layer 62a and the third layer 62c. The second shaped layer 62 includes the first material region 51 formed of the first material 50 and the second material region 53 formed of the second material 52. When viewed from the stacking direction, the area nS₁₁ of the first material region 51a of the first layer 62a is larger than the area nS₄₁ of the first material region 51d of the fourth layer 62d, the area nS₂₂ of the second material region 53b of the second layer 62b is larger than the area nS₃₂ of the second material region 53c of the third layer 62c, and the area nS₃₁ of the first material region 51c of the third layer 62c is larger than the area nS₁₁ of the first material region 51a of the first layer 62a. According to the three-dimensional shaping apparatus 100, the area nS₁₁ of the first material region 51a of the first layer 62a is larger than the area nS₄₁ of the first material region 51d of the fourth layer 62d, and therefore, in the first layer 62a, the area of the first material region 51 is not the smallest in the second stacked body 72. According to this, the adhesion of the first shaped layer 60 to the second shaped layer 62 can be enhanced. If the area nS₁₁ is the smallest in the second stacked body, the area of the second material region that is in contact with the first shaped layer becomes large, and therefore, the adhesion of the first shaped layer to the second shaped layer is deteriorated.

Further, according to the three-dimensional shaping apparatus 100, when viewed from the stacking direction, the area nS₂₂ of the second material region 53b of the second layer 62b is larger than the area nS₃₂ of the second material region 53c of the third layer 62c. Therefore, in the second layer 62b, the area of the second material region 53 is not the smallest in the second stacked body 72. According to this, the adhesion of the second shaped layer 62 to the third shaped layer 64 can be enhanced.

Further, according to the three-dimensional shaping apparatus 100, when viewed from the stacking direction, the area nS₃₁ of the first material region 51c of the third layer 62c is larger than the area nS₁₁ of the first material region 51a of the first layer 62a. Therefore, for example, as compared to a case where the area of the first material region gradually decreases from the first layer to the second layer, an anchor effect is easily exhibited, and the adhesion of the first shaped layer 60 to the second shaped layer 62 can be enhanced.

Further, according to the three-dimensional shaping apparatus 100, when viewed from the stacking direction, the area nS₄₁ of the first material region 51d of the fourth layer 62d is smaller than the area nS₁₁ of the first material region 51a of the first layer 62a. Therefore, for example, as compared to a case where the area of the first material region gradually increases from the first layer to the third layer, an anchor effect is easily exhibited, and the adhesion of the first shaped layer 60 to the second shaped layer 62 can be enhanced.

According to the three-dimensional shaping apparatus 100, when viewed from the stacking direction, the area nS₁₁ of the first material region 51a of the first layer 62a and the area nS₂₂ of the second material region 53b of the second layer 62b are mutually equal. Therefore, according to the three-dimensional shaping apparatus 100, as compared to a case where the area nS₁₁ and the area nS₂₂ are mutually different, a difference between the adhesion of the first shaped layer 60 to the second shaped layer 62 and the adhesion of the second shaped layer 62 to the third shaped layer 64 can be made small. If the difference therebetween is large, a load is concentrated and cracking or peeling occurs in the layers whose adhesion is smaller.

### 2. Modifications

Next, a three-dimensional shaping apparatus according to a modification of the present embodiment will be described. Hereinafter, in the three-dimensional shaping apparatus according to the modification of the present embodiment, points different from the examples of the three-dimensional shaping apparatus 100 according to the above-mentioned present embodiment will be described, and the description of the same points will be omitted.

The three-dimensional shaping apparatus according to the modification of the present embodiment is different from the above-mentioned three-dimensional shaping apparatus 100 in that a tensile strength F₁₁ in the stacking direction of the first material region 51a of the first layer 62a and a tensile strength F₂₂ in the stacking direction of the second material region 53b of the second layer 62b are mutually equal.

For example, when, in one convex portion 73, the 0.2% yield strength of the first material region 51a is represented by α1, the 0.2% yield strength of the second material region 53b is represented by σ2, and the number of convex portions 73 is represented by n, the tensile strength F₁₁ in the stacking direction of the first material region 51a of the first layer 62a and the tensile strength F₂₂ in the stacking direction of the second material region 53b of the second layer 62b are represented as follows.

F₁₁=σ₁×πR₁²×n

F₂₂=σ₂×(A²−πR₂²)×n

Therefore, when the tensile strength F₁₁ and the tensile strength F₂₂ are mutually equal, the radius R₁ is represented as follows.

$${R}_{1} = \sqrt{\frac{{σ}_{2}}{{σ}_{1}} \times ( \frac{{A}^{2}}{π} - {R}_{2}^{2} )}$$

In the three-dimensional shaping apparatus according to the modification of the present embodiment, the tensile strength F₁₁ and the tensile strength F₂₂ are mutually equal, and therefore, the adhesion of the first shaped layer 60 to the second shaped layer 62 and the adhesion of the second shaped layer 62 to the third shaped layer 64 can be made equal.

In the above-mentioned example, an example in which the relative positions between the stage 20 and the first material supply unit 120, between the stage 20 and the second material supply unit 130, and between the stage and the laser 140 can be simultaneously changed is described, however, the first material supply unit 120, the second material supply unit 130, and the laser 140 may be configured to be separately moved. Further, the laser 140 may be fixed, and the laser beam may be moved using a Galvano mirror. In this case, the Galvano mirror is controlled by the control unit 40.

Further, in the above-mentioned example, an example using the flat screw 123 is described, however, in place of the flat screw 123, an in-line screw or a head using an FDM method may be used.

Further, in the above-mentioned example, a case where the first material 50 is a metal material and the second material 52 is a ceramic material is described, however, the first material 50 may be a ceramic material and the second material 52 may be a metal material. Further, both the first material 50 and the second material 52 may be metal materials or may be ceramic materials or may be materials other than metal materials and ceramic materials as long as the first material 50 and the second material 52 are mutually different materials.

Further, in the first material supply unit 120 and the second material supply unit 130, as a material that is kneaded and supplied together with the first material 50 and the second material 52, for example, synthetic resins such as an acrylic resin, an epoxy resin, a silicone resin, and PVA (polyvinyl alcohol) are exemplified. As a solvent, for example, methanol, ethanol, ethylene glycol, propylene glycol, methyl acetate, ethyl acetate, benzene, toluene, xylene, and the like are exemplified. A binder and a solvent are vaporized, for example, by irradiation with a laser beam. Note that it is acceptable that the solvent is vaporized by a lamp or the like in a pre-drying step after coating.

The above-mentioned embodiments and modifications are examples, and the present disclosure is not limited thereto. For example, it is also possible to appropriately combine the respective embodiments and the respective modifications.

The present disclosure includes substantially the same configuration, for example, a configuration having the same function, method, and result, or a configuration having the same object and effect as the configuration described in the embodiments. Further, the present disclosure includes a configuration in which a part that is not essential in the configuration described in the embodiments is substituted. Further, the present disclosure includes a configuration having the same operational effect as the configuration described in the embodiments, or a configuration capable of achieving the same object as the configuration described in the embodiments. In addition, the present disclosure includes a configuration in which a known technique is added to the configuration described in the embodiments.

From the above-mentioned embodiments, the following contents are derived.

One aspect of a three-dimensional shaping apparatus includes a stage, a first material supply unit that supplies a first material, a second material supply unit that supplies a second material different from the first material, and a control unit, in which the control unit performs a process of supplying the first material onto the stage by controlling the first material supply unit, thereby forming a first shaped layer, a process of supplying the first material onto a first region of the first shaped layer by controlling the first material supply unit, and supplying the second material onto a second region that is different from the first region of the first shaped layer by controlling the second material supply unit, thereby forming a second shaped layer, a process of repeating supply of the first material and supply of the second material multiple times, thereby forming a stacked body composed of multiple second shaped layers, and a process of supplying the second material onto the stacked body by controlling the second material supply unit, thereby forming a third shaped layer, a first layer among the multiple second shaped layers constituting the stacked body is in contact with the first shaped layer, a second layer among the multiple second shaped layers constituting the stacked body is in contact with the third shaped layer, a third layer among the multiple second shaped layers constituting the stacked body is located between the first layer and the second layer, a fourth layer among the multiple second shaped layers constituting the stacked body is located between the first layer and the third layer, the second shaped layer includes a first material region formed of the first material and a second material region formed of the second material, and when viewed from a stacking direction of the stacked body, an area of the first material region of the first layer is larger than an area of the first material region of the fourth layer, an area of the second material region of the second layer is larger than an area of the second material region of the third layer, and an area of the first material region of the third layer is larger than an area of the first material region of the first layer.

According to the three-dimensional shaping apparatus, the adhesion of the first shaped layer to the second shaped layer and the adhesion of the second shaped layer to the third shaped layer can be enhanced.

In one aspect of the three-dimensional shaping apparatus, when viewed from the stacking direction, the area of the first material region of the first layer and the area of the second material region of the second layer may be made mutually equal.

According to the three-dimensional shaping apparatus, a difference between the adhesion of the first shaped layer to the second shaped layer and the adhesion of the second shaped layer to the third shaped layer can be made small.

In one aspect of the three-dimensional shaping apparatus, a tensile strength in the stacking direction of the first material region of the first layer and a tensile strength in the stacking direction of the second material region of the second layer may be made mutually equal.

According to the three-dimensional shaping apparatus, the adhesion of the first shaped layer to the second shaped layer and the adhesion of the second shaped layer to the third shaped layer can be made equal.

What is claimed is:

1. A three-dimensional shaping apparatus, comprising:
a stage;
a first material supply unit that supplies a first material;
a second material supply unit that supplies a second material different from the first material; and
a control unit, wherein
the control unit performs
a process of supplying the first material onto the stage by controlling the first material supply unit, thereby forming a first shaped layer,
a process of supplying the first material onto a first region of the first shaped layer by controlling the first material supply unit, and supplying the second material onto a second region that is different from the first region of the first shaped layer by controlling the second material supply unit, thereby forming a second shaped layer,
a process of repeating supply of the first material and supply of the second material multiple times, thereby forming a stacked body composed of multiple second shaped layers, and
a process of supplying the second material onto the stacked body by controlling the second material supply unit, thereby forming a third shaped layer,
a first layer among the multiple second shaped layers constituting the stacked body is in contact with the first shaped layer,
a second layer among the multiple second shaped layers constituting the stacked body is in contact with the third shaped layer,
a third layer among the multiple second shaped layers constituting the stacked body is located between the first layer and the second layer,
a fourth layer among the multiple second shaped layers constituting the stacked body is located between the first layer and the third layer,
the second shaped layer includes
a first material region formed of the first material and
a second material region formed of the second material, and
when viewed from a stacking direction of the stacked body,
an area of the first material region of the first layer is larger than an area of the first material region of the fourth layer,
an area of the second material region of the second layer is larger than an area of the second material region of the third layer, and
an area of the first material region of the third layer is larger than an area of the first material region of the first layer.

2. The three-dimensional shaping apparatus according to claim 1, wherein
when viewed from the stacking direction, the area of the first material region of the first layer and the area of the second material region of the second layer are mutually equal.

3. The three-dimensional shaping apparatus according to claim 1, wherein
a tensile strength in the stacking direction of the first material region of the first layer and a tensile strength in the stacking direction of the second material region of the second layer are mutually equal.
